(19) United States
(12) Patent Application Publication
(10) Pub. No.: US 2026/0230196 A1
(43) Pub. Date: Aug. 6, 2026

(54) METHODS, APPARATUS AND COMPUTER-READABLE MEDIA RELATED TO THE ESTIMATION OF PHASE ERROR

(71) Applicant: Telefonaktiebolaget LM Ericsson (publ), Stockholm (SE)

(72) Inventors: Hao ZHANG, Beijing (CN); Christian BRAUN, Vallentuna (SE); Ang FENG, Solna (SE)

(21) Appl. No.: 19/147,791

(22) PCT Filed: Feb. 6, 2023
(86) PCT No.: PCT/CN2023/074498

§ 371 Date: Jul. 14, 2025

(51) Int. Cl. H04B 17/12; H04B 7/06

(52) U.S. Cl. CPC H04B 17/12; H04B 7/0626; H04B 7/0639

(57) ABSTRACT

A method by a network node estimates phase error between signals transmitted by a multi-antenna system. A first antenna transmits first reference signals to a wireless device and a second antenna transmits second reference signals to the wireless device. The first reference signals are configured with a phase ramp relative to the second reference signals over a frequency range of a carrier of the multi-antenna system. The method receives, from the wireless device, feedback based on the first and second reference signals. The feedback indicates quantized measurements by the wireless device of phase difference between the first and second reference signals over the frequency range. The method applies a fitting algorithm to the quantized measurements of phase difference to generate a fitted relationship of the phase difference with respect to frequency over the frequency range; and removes, from the fitted relationship, the phase ramp to generate an estimate of the phase error.

### TECHNICAL FIELD

Embodiments of the present disclosure relate to the estimation of phase error, and particularly to the estimation of phase error between signals transmitted by a first antenna and a second antenna of a multi-antenna system.

### BACKGROUND

Coherent transmission and/or reception of signals from multiple antennas is a key feature of 5G and future 6G massive Multiple-Input, Multiple-Output (MIMO) systems. These multiple antennas may, for example, be located at a single Transmission and Reception Point (TRP). Alternatively, one or more of the multiple antennas may be located on different TRPs of a multi-TRP configuration.

Coherent transmission and/or reception of signals from multiple antennas is achieved, in part, by estimating phase differences between the signals and compensating for these phase differences at the point of reception and/or transmission (e.g., by performing antenna calibration (AC)).

One way of estimating phase differences between downlink (DL) signals transmitted from multiple antennas (e.g., transmitted on multiple antenna branches) is by utilising DL channel state information (CSI) feedback, such as Precoding Matrix Indicator (PMI) feedback, provided by a wireless device receiving the DL signals (sometimes referred to in this disclosure as an “assistant wireless device”).

For example, a multi-antenna system can be configured virtually as a two-antenna, rank-1 system with two CSI reference signal (RS) ports (one to each antenna). The phase difference between signals transmitted using the two DL antenna branches can be estimated by transmitting CSI-RSs from the two CSI-RS ports to an assistant wireless device. The assistant wireless device receives the CSI-RSs and transmits, to the network, PMI feedback which includes a co-phasing component. This co-phasing component indicates a phase difference between the DL signals and is reported per sub-band of the total carrier bandwidth.

However, the co-phasing component in PMI feedback has coarse granularity. That is, according to 3GPP specifications (e.g., 3GPP TS 38.214 V16.10.0), the PMI co-phasing component has Quadrature Phase Shift Keying (QPSK) resolution (i.e., a resolution of 90 degrees) when using type I and type II codebooks and, in some cases, 8 Phase Shift Keying (PSK) resolution when using the type II codebook.

For example, Table 1 below illustrates the different values that a co-phasing component can have according to various indices of a Type I codebook (when used for a two-port multi-antenna configuration).

TABLE 1
Codebooks for 1-layer and 2-layer CSI reporting using antenna ports
3000 to 3001

| Codebook | Number of layers υ | |
|---|---|---|
| index | 1 | 2 |
| 0 | $\frac{1}{\sqrt{2}} [ \begin{matrix}1 \\ 1\end{matrix} ]$ | $\frac{1}{2} [ \begin{matrix}1 & 1 \\ 1 & - 1\end{matrix} ]$ |
| 1 | $\frac{1}{\sqrt{2}} [ \begin{matrix}1 \\ j\end{matrix} ]$ | $\frac{1}{2} [ \begin{matrix}1 & 1 \\ j & - j\end{matrix} ]$ |
| 2 | $\frac{1}{\sqrt{2}} [ \begin{matrix}1 \\ - 1\end{matrix} ]$ | — |
| 3 | $\frac{1}{\sqrt{2}} [ \begin{matrix}1 \\ - j\end{matrix} ]$ | — |

It can be seen from Table 1 that, when there is a single layer, signals from the two antenna ports can be combined with co-phasing of 0, 90, 180 and 270 deg. Whilst these values may be sufficient for the reasonable phase coherent addition of signals for DL traffic (e.g., the Physical Downlink Shared Channel (PDSCH)), improved performance can be achieved via calibration of the antennas prior to transmission of the traffic. However, the phase difference between signals transmitted by antennas is often smaller than 90 degrees. These small phase differences cannot be accurately reported using a co-phasing component when attempting to perform AC. For example, more advanced features of communication networks may require more precise phase control (e.g. beam nulling for Multi User MIMO (MU-MIMO) purposes). In these cases, highly accurate phase calibration of the antennas involved in the transmission may be necessary.

### SUMMARY

To overcome this granularity limitation of the co-phasing component, one option is to iteratively transmit CSI-RSs from the multiple antennas to the assistant wireless device. For each iteration, the phase of a CSI-RS transmitted from a given one of the antennas is rotated by a small amount (e.g., 5 deg). The assistant wireless device then measures the received CSI-RSs (including the phase-rotated CSI-RS) and transmits PMI feedback for each iteration to the network. By performing this operation multiple times, the true phase difference between signals transmitted by the multiple antennas can be found with increased accuracy. However, due to the iterative nature of this method, multiple rotations of the CSI-RSs are needed (often between 30 and 100 phase rotations) which takes a significant amount of time, consumes excessive amounts of power and has a negative impact on the capacity of the system. For example, in order to find the phase difference with a resolution of 5 degrees by iteratively reporting PMI feedback using a co-phasing component with 90 degree resolution, 18 iterations are needed (i.e., 90/5=18). Also, if the assistant wireless device moves over the course of the multiple iterations, performance of the method can be degraded.

Certain aspects of the disclosure and their embodiments may provide solutions to these or other challenges.

According to a first aspect of the present disclosure, there is provided a method performed by a network node for estimating phase error between signals transmitted by a first antenna and a second antenna of a multi-antenna system. The first antenna is configured to transmit first reference signals to a wireless device and the second antenna is configured to transmit second reference signals to the wireless device. The first reference signals are configured with a phase ramp relative to the second reference signals over a frequency range of a carrier of the multi-antenna system. The method comprises receiving, from the wireless device, feedback based on the first reference signals and the second reference signals. The feedback comprises indications of quantized measurements by the wireless device of phase difference between the first reference signals and the second reference signals over the frequency range. The method further comprises: applying a fitting algorithm to the quantized measurements of phase difference to generate a fitted relationship of the phase difference with respect to frequency over the frequency range; and removing, from the fitted relationship, the phase ramp to generate an estimate of the phase error between signals transmitted by the first antenna and the second antenna.

According to a second aspect of the present disclosure, there is provided a network node for estimating phase error between signals transmitted by a first antenna and a second antenna of a multi-antenna system. The first antenna is configured to transmit first reference signals to a wireless device and the second antenna is configured to transmit second reference signals to the wireless device. The first reference signals are configured with a phase ramp relative to the second reference signals over a frequency range of a carrier of the multi-antenna system. The network node comprises processing circuitry configured to cause the network node to receive, from the wireless device, feedback based on the first reference signals and the second reference signals. The feedback comprises indications of quantized measurements by the wireless device of phase difference between the first reference signals and the second reference signals over the frequency range. The processing circuitry is further configured to cause the network node to: apply a fitting algorithm to the quantized measurements of phase difference to generate a fitted relationship of the phase difference with respect to frequency over the frequency range; and remove, from the fitted relationship, the phase ramp to generate an estimate of the phase error between signals transmitted by the first antenna and the second antenna.

Certain embodiments may provide one or more of the following technical advantage(s). For example, phase differences between reference signals transmitted from two or more antennas can be accurately determined without iteratively rotating the phase of reference signals transmitted from one of the antennas. That is, the phase difference between the reference signals can be accurately determined based on a single set of reference signals transmitted from the multiple antennas to the assistant wireless device. As such, less time and less energy are required to estimate phase errors between signals transmitted by multiple antennas, reducing the network resources required to perform the estimation procedure and reducing the likelihood that the assistant wireless device will move during the estimation procedure.

Furthermore, due to the simplified nature of the disclosed embodiments relating to methods for estimating phase errors, embodiments of the present application can be employed for large antenna arrays in single-TRP (e.g., advanced antenna systems (AASs)) or multi-TRP (e.g., distributed MIMO (D-MIMO)) applications.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 is a schematic diagram illustrating a communication network comprising a multi-antenna system according to embodiments of the disclosure;

FIG. 2 is a schematic diagram illustrating a communication network comprising a multi-antenna system according to further embodiments of the disclosure;

FIG. 3 is a schematic diagram illustrating a base station operable in accordance with some embodiments of the disclosure;

FIG. 4 is a flowchart showing a method performed by a network node for estimating phase error in accordance with some embodiments;

FIG. 5 is a graph illustrating an estimated phase difference between reference signals in comparison to the actual phase difference between the reference signals;

FIG. 6 is a graph illustrating an estimated phase difference between reference signals in comparison to the actual phase difference between the various reference signals;

FIG. 7 is a graph illustrating a root-mean-square error of an estimated phase error against a number of frequency sub-bands used in a procedure to estimate the phase error; and

FIG. 8 is a schematic diagram illustrating a network node operating in accordance with some embodiments for estimating phase error.

### DETAILED DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

The description below sets forth example embodiments according to this disclosure. Further example embodiments and implementations will be apparent to those having ordinary skill in the art. Further, those having ordinary skill in the art will recognize that various equivalent techniques may be applied in lieu of, or in conjunction with, the embodiments discussed below, and all such equivalents should be deemed as being encompassed by the present disclosure.

Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate, the technology can additionally be considered to be embodied entirely within any form of computer-readable memory, such as solid-state memory, magnetic disk, or optical disk containing an appropriate set of computer instructions that would cause a processor to carry out the techniques described herein.

Embodiments of the present disclosure relate to methods performed by a network node for estimating phase error between signals transmitted from antennas of a multi-antenna system. By estimating the phase error, the antennas can be calibrated to ensure that this phase error is compensated for. As such, coherent transmission and/or reception of signals transmitted from the antennas can be achieved.

In particular, to overcome the granularity issues faced by conventional methods of estimating phase error, embodiments of the present disclosure employ an assistant wireless device to measure reference signals transmitted from two antennas of a multi-antenna system, where a phase ramp is applied to reference signals transmitted from one of the antennas over a frequency range of a carrier of the multi-antenna system. This phase ramp adjusts the phase of the reference signal(s) to which it is applied with respect to the frequency of the carrier, such that the phase difference between the transmitted reference signals varies with respect to the frequency of the carrier. As such, the assistant wireless device observes and measures a frequency-variable phase difference between the transmitted reference signals.

According to embodiments of the present disclosure, the assistant wireless device transmits feedback to the network node comprising indications of quantized measurements by the wireless device of phase difference between the received reference signals over the frequency range. As a result of the applied phase ramp, at least some of the quantized values of phase difference vary in magnitude with respect to the frequency of the carrier. Furthermore, due to the nature of quantization, a number of the quantized values are likely to be overestimates of the phase difference between the transmitted reference signals and a number of the quantized values are likely to be underestimates of the phase difference between the transmitted reference signals.

The network node is therefore provided with multiple estimates of phase difference between the transmitted reference signals, where, due to the applied phase ramp, the estimates of phase difference are not necessarily limited to a single quantized value over the frequency of the carrier. That is, the quantized measurements of phase difference can be expected to vary over the frequency of the carrier. This is contrary to conventional methods of estimating phase difference, where, due to the phase error between transmitted reference signals exhibiting only a small variation with respect to the frequency of the carrier (typically much less than the quantized values reported by the wireless device), the co-phasing component is reported (e.g., per frequency sub-band) with little or no variation with respect to the frequency of the carrier.

Using the received feedback, the network node can apply a fitting algorithm to the quantized measurements of phase difference to generate a fitted relationship (e.g., a fitted or interpolated model) of phase difference between the received reference signals with respect to frequency over the frequency range. By removing the phase ramp from the fitted relationship, an estimate of the phase error between the transmitted reference signals can be found with a higher resolution than conventional methods of estimating phase difference between transmitted signals (e.g., 90 deg resolution). This estimated phase can then be compensated for, e.g., by antenna calibration. The use of a phase ramp and a fitting algorithm thus allows for a phase error at a given frequency to be obtained with a higher resolution than if it were measured by the assistant wireless device and reported as a quantized measurement.

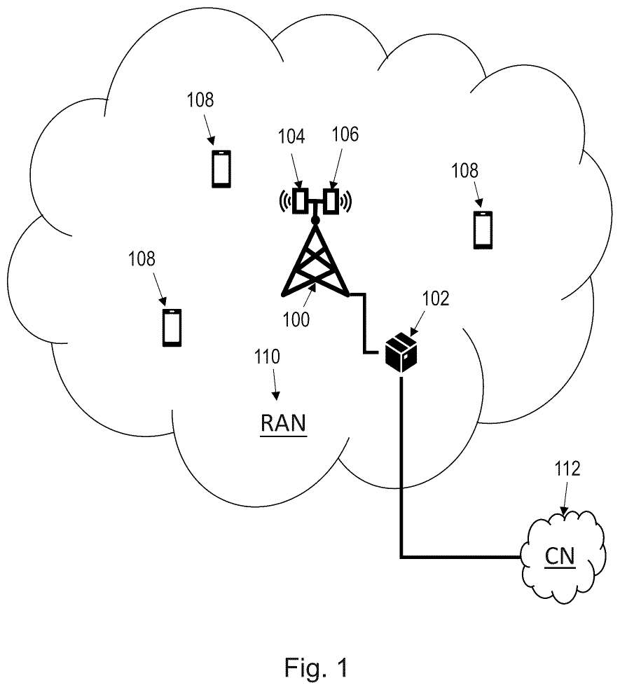

Methods of the present disclosure may be implemented by any suitable network architecture comprising a multi-antenna system. Examples of such architectures are illustrated in FIGS. 1, 2 and 3, discussed in detail below.

FIG. 1 illustrates a communication network according to embodiments of the disclosure comprising a multi-antenna system in which multiple antennas are located on a single TRP 100. The multi-antenna system (e.g., a multi-antenna system comprising an AAS) thus comprises a first antenna 104 and a second antenna 106 which, in this embodiment, are located on a single TRP 100. The communication network further comprises a Radio Access Network (RAN) 110 of which the TRP 100 forms part, and a Core Network (CN) 112 to which the TRP 100 is connected. The TRP 100 serves one or more wireless devices 108 (e.g., User Equipment (UE)) located within the cell of the TRP 100. One of the one or more wireless devices 108 may be selected to assist a phase error estimation procedure according to embodiments of the present disclosure (and therefore may be referred to as an assistant wireless device 108).

In the illustrated embodiment, the first and second antennas 104, 106 correspond to separate aerials. However, it will be apparent to those skilled in the art that the first and second antennas 104, 106 may be arranged differently. For example, the first and second antennas may instead comprise antenna arrays instead of aerials. In another example, the first and second antennas may correspond to different antenna elements or groups of antenna elements (e.g., panels) within the same antenna array or different antenna arrays.

In some embodiments, the TRP 100 may be a RAN node. As used herein, the term “RAN node” refers to equipment capable, configured, arranged and/or operable to communicate directly or indirectly with a wireless device 108 or UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and New Radio NodeBs (gNBs)). The RAN node facilitates direct or indirect connection of wireless devices 108 in its cell, such as by connecting the wireless devices 108 to the CN 112 over one or more wireless connections.

The CN 112 includes one more CN nodes that are structured with hardware and software components. Example CN nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The communication network further comprises a network node 102 which is coupled (directly or indirectly) to the TRP 100. The network node 102 may additionally be coupled to other nodes in the RAN 110, and/or the CN 112. The network node 102 may be located in the RAN 110 (as illustrated) or the CN 112.

In some embodiments, the network node 102 is co-located with the multi-antenna system (e.g., the first and second antennas 104, 106). For example, the network node 102, first antenna 104, and second antenna 106 may all be located at the TRP 100. Alternatively, the network node 102 may be located remotely from the multi-antenna system (e.g., the first and second antennas 104, 106). For example, the TRP 100 may be implemented as part of a distributed base station architecture. In this case, the first and second antennas 104, 106 may be located on a distributed unit of the distributed base station; the network node 102 may be implemented in or comprise a centralized unit of the base station.

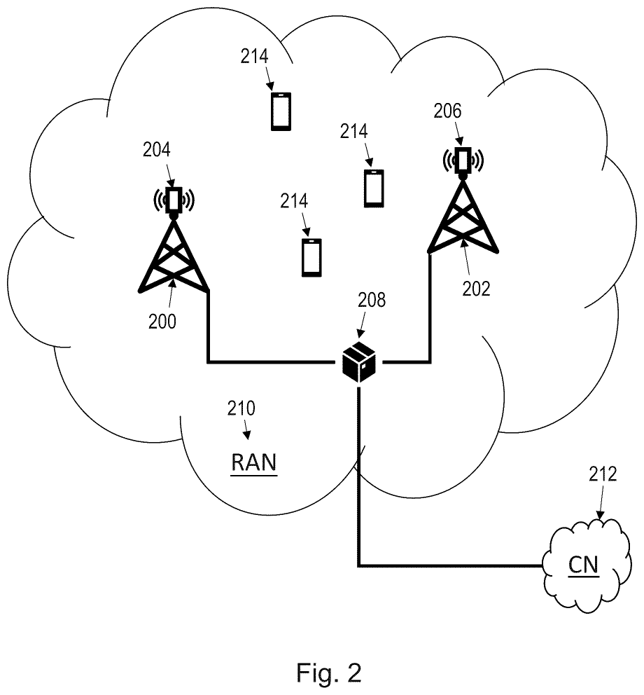

FIG. 2 illustrates a communication network according to embodiments of the disclosure comprising a multi-antenna system in which antennas are located on different TRPs 200, 202. The multi-antenna system (e.g., a multi-antenna system comprising a D-MIMO) thus comprises a first antenna 204 and a second antenna 206 located respectively on a first TRP 200 and a second TRP 202. The communication network further comprises a RAN 210 and a CN 212 to which the first and second TRPs 200, 202 are connected. The first and second TRPs 200, 202 serve one or more wireless devices 214 (e.g., UEs) located within the cell or cells of the first and second TRPs 200, 202. One of the one or more wireless devices 214 may be selected to assist a phase error estimation procedure according to the present disclosure (and therefore may be referred to as an assistant wireless device 214).

In the illustrated embodiment, the first and second antennas 204, 206 correspond to separate aerials. However, as with FIG. 1, it will be apparent to those skilled in the art that the first and second antennas 204, 206 may be arranged differently. For example, the first and second antennas may instead comprise antenna arrays instead of aerials. In another example, the first and second antennas may correspond to different antenna elements or groups of antenna elements (e.g., panels) within different antenna arrays.

The first and second TRPs 200, 202 may be RAN nodes, as described above. The RAN node facilitates direct or indirect connection of wireless devices 214 in its cell, such as by connecting the wireless devices 214 to the CN 212 over one or more wireless connections. The CN 212 includes one more CN nodes that are structured with hardware and software components, as described above with respect to the CN 112.

The communication network further comprises a network node 208 which is coupled (indirectly or directly) to the first and second TRPs 200, 202. The network node 208 may additionally be coupled to other nodes in the RAN 210, and/or the CN 212. The network node 208 may be located in the RAN 210 (as illustrated) or the CN 212.

In some embodiments, the network node 208 may be co-located with either the first antenna 204 or the second antenna 206. For example, the network node 208 may be located with the first antenna 204 on the first TRP 200 or the second antenna 206 on the second TRP 202. Alternatively, the network node 208 may be located remotely from the first and second antennas, but communicatively coupled to the multi-antenna system. For example, the TRPs 200, 202 may be implemented as part of a distributed base station architecture. In this case, the first and second antennas 204, 206 may be located on separate distributed units of the distributed base station; the network node 208 may be implemented in or comprise a centralized unit of the distributed base station.

FIG. 1 thus shows an example of a multi-antenna system in which multiple antennas are located on the same TRP. FIG. 2 shows an example in which multiple antennas are located on separate TRPs. Those skilled in the art will appreciate that these examples may be combined without departing from the scope of the appended claims. That is, a multi-antenna system may comprise multiple antennas on the same TRP and also antennas on separate TRPs.

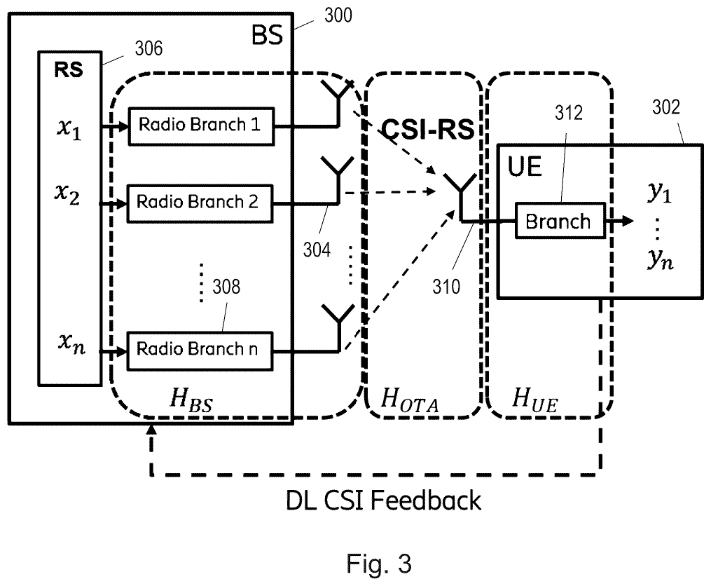

FIG. 3 is a schematic diagram illustrating a BS 300 operable to perform methods according to the present disclosure for estimating phase error.

The BS 300 comprises multiple antennas 304, and is operable to transmit reference signals (RS) 306 over those antennas to a user equipment (UE) 302 comprising an antenna 310. The UE 302 may also be referred to as an assistant wireless device 302.

Radio branches 308 of the BS 300 are respectively associated with the plurality of antennas 304 of the BS 300, wherein each branch 308 has a branch index, n. Similarly, a radio branch 312 of the UE 302 is associated with the UE antenna 310. These radio branches 308, 312 are operable for the transmission and/or reception of signals between the BS 300 and the UE 302.

The reference signals (e.g., CSI-RSs) are therefore transmitted over the antennas 304 via respective radio branches 308. The transmitted reference signals are denoted as x₁, x₂, x₃, . . . xₙ, where n is the index of the radio branch 308 used for the transmission of the reference signal. In this analysis, we assume 1:1 mapping between BS physical radio branch and logical CSI-RS port. It can be understood that a different mapping can also be used (e.g. one CSI-RS port may be mapped to multiple BS physical radio branches).

As a group, the transmitted reference signals are denoted as X. In the illustrated embodiment, each reference signal is transmitted over a respective antenna. Those skilled in the art will appreciate that, in alternative embodiments, the same reference signal may be transmitted over more than one antenna 304. Additionally, the antennas 304 may be arranged on different network nodes or TRPs (e.g., as illustrated with respect to FIG. 2).

The UE 302 is operable to receive, via its antenna 310, the reference signals x₁, x₂, x₃, . . . xₙ over the radio branch 312 associated with the antenna 310. The received reference signals are denoted as y₁, y₂, y₃, . . . yₙ. As a group, the received reference signals are denoted as Y.

The following analysis considers an embodiment in which reference signals are transmitted from just two antennas of the BS 300 (e.g., n=0, 1). In other words, a first antenna (e.g., n=1) of the BS 300 is configured to transmit first reference signals to the UE 302 and a second antenna (e.g., n=0) of the BS 300 is configured to transmit second reference signals to the UE 302. For example, the first and second reference signals may comprise CSI-RSs, which exhibit orthogonal properties between antenna branches.

From their point of generation, the reference signals transmitted from the antennas 304 of the multi-antenna system undergo channel impairments resulting from: the BS 300 radio branches 308 (H_{BS}), the over-the-air (OTA) channel (H_{OTA}) that exists between the BS 300 and the UE 302, and the UE 302 radio branch 312 (H_{UE}). As a result, the reference signals received at the UE 302, Y, can be written as

$$Y ( k , n ) = {H}_{UE} ( k ) {H}_{OTA} ( k , n ) {H}_{BS} ( k , n ) X ( k , n ) , \qquad ( 1 )$$

where k is a frequency index indicating a transmission frequency (e.g., a subcarrier or sub-band) of the multi-antenna system. A subcarrier has a finer resolution than a sub-band, as a sub-band comprises a block of subcarriers. CSI-RSs have sub-carrier resolution. Using frequency indices of higher resolution results in smaller portions of the reference signals being measured by the UE 302 at each frequency index, which may be appropriate where the reference signals received by the UE 302 are particularly strong. In other embodiments, the frequency index may refer to a different sub-division of the bandwidth of the carrier.

For the purposes of the following analysis, the above formulation of Y in equation 1 can be simplified based on the assumptions listed below:
1) For the embodiments of FIG. 3, the UE 302 only has one antenna 310 associated with one radio branch 312. As such, the impact of this radio branch 312 on Y is common for all BS 300 branch indices, n. As such, H_{UE} can be omitted from the following analysis for simplicity (e.g., by setting H_{UE}=1 in equation 1 above).
2) It can be assumed that the UE 302 is in a boresight direction (i.e., in a direct line of sight (LOS)) of the BS 300 antennas 304, and thus experiences an Additive White Gaussian Noise (AWGN) channel with a very good Signal-to-Noise Ratio (SNR). As such, the impact of the OTA channel on Y can also be assumed to be minimal, and therefore omitted from the following analysis for simplicity (e.g., by setting H_{OTA}=1 in equation 1 above). The assumption that the UE 302 is in a boresight direction of the BS 300 antennas 304 is motivated by the following considerations:
   For antenna systems with four transmit and four receive antennas (4T4R), the DL AC objective is to align the beam directions between the two antenna polarizations. There is no requirement on absolute beam direction. It is therefore sufficient to use an arbitrarily positioned UE 302 with LOS conditions for sufficient AC accuracy.
   For antenna systems with eight transmit and eight receive antennas (8T8R) and higher, there are requirements on absolute beam directions, and thus the unknown positions of UEs 302 may impact H_{OTA}. However, this impact can be mitigated by pre-coding the transmitted (CSI-) reference signal, X, according to an estimated direction of arrival (DoA) of X in the uplink (UL) direction.

Note that, in any case, those skilled in the art will be aware of multiple methods for mitigating the effects of the UE not being positioned in a boresight direction of the BS 300 antennas 304.

Therefore, whilst multipath propagation and poor SNR may impact the measurements of Y at the UE 302 (and thus impact the resulting phase error estimation), they are not considered in the present disclosure. As such, under the above assumptions, the only channel of interest affecting the received reference signal, Y, is H_{BS}. In embodiments of the disclosure, HBs may be primarily the result of phase error (e.g., DL AC error) between the multiple antennas 304.

The reference signals, Y, received at the UE 302 can therefore be simplified to

$$Y ( k , n ) = {H}_{BS} ( k , n ) X ( k , n ) . \qquad ( 2 )$$

The UE 304 measures the received signals Y and provides feedback on those measurements (e.g., DL CSI feedback) to the BS 300. The feedback may then be used to account and/or compensate for the phase error between the antennas 304 (e.g., such that H_{BS}(k, n) is substantially equal to 1).

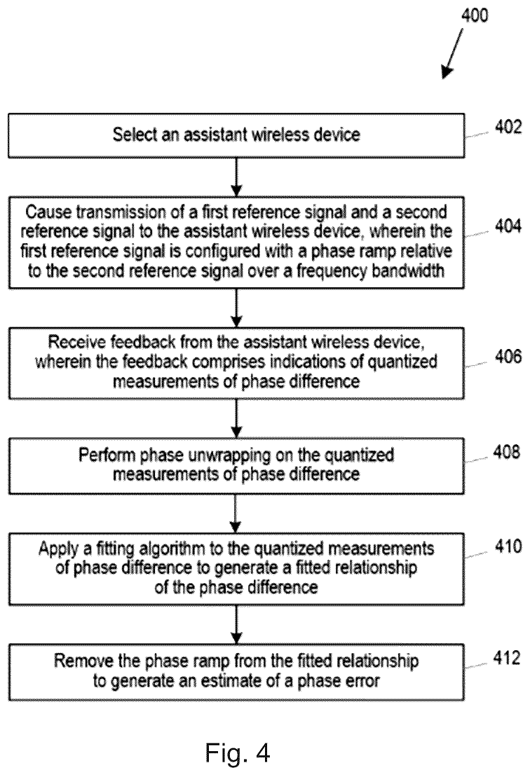

FIG. 4 is a flowchart showing a method 400 according to embodiments of the disclosure for estimating phase error between signals transmitted by a first antenna and a second antenna of a multi-antenna system. The method may be performed by a network node such as the network nodes 102, 208, 300 described above, thus the first and second antennas may correspond to those antennas 104, 106, 204, 206, 304 described above.

The method begins in step 402, in which a wireless device or UE is selected to be an assistant wireless device for the purposes of estimating the phase error. That is, the method 400 comprises interactions between a multi-antenna system and a single UE. Estimates of the phase error between the antennas of the multi-antenna system are obtained based on those interactions, and used to compensate for the phase error when communicating with the assistant wireless device and also any other wireless device served by the multi-antenna system. Those skilled in the art will appreciate that the method 400 may nonetheless be repeated with multiple wireless devices.

The assistant wireless device may be chosen as a wireless device with which the base multi-antenna system has line-of-sight communication, such that the assumptions set out above with respect to FIG. 3 are more likely to be valid (particularly such that the effect of the OTA interface can be neglected). For example, the assistant wireless device may be selected on the basis of the wireless device reporting radio conditions above a threshold. In other examples, an assistant wireless device may be selected based on traffic load, usage, available power, or other metrics of the wireless device. For example, a wireless device may be selected if it has more than a threshold amount of power available to it (e.g., more than a threshold battery level). Additionally or alternatively, a wireless device may be selected as assistant wireless device if it is idle (e.g., otherwise not busy with user traffic).

In step 404, the network node causes transmission of a first reference signal and a second reference signal to the assistant wireless device. As will be discussed in more detail below, the first reference signal is configured with a phase ramp relative to the second reference signal over a frequency bandwidth. For example, where the network node is implemented at a TRP comprising multiple antennas, step 404 may comprise the network node sending the first and second reference signals to the antennas for transmission. In other examples, where the network node is implemented remotely from one or more of the TRPs of the multi-antenna system, step 404 may comprise the network node instructing the TRPs to transmit the first and second reference signals.

As previously discussed, the BS 300 is operable to transmit reference signals, X, from the multiple antennas 304 of the BS 300 to the UE 302. However, according to embodiments of the present disclosure, when performing a procedure to estimate phase error of signals transmitted from the multiple antennas 304 of the multi-antenna system, the BS 300 applies a phase ramp to reference signals transmitted from one of the antennas of the multi-antenna system (e.g., n=1). Thus at least one antenna transmits reference signals which are shifted in phase (by virtue of the phase ramp) with respect to reference signals transmitted by at least one other antenna. The phase ramp varies with respect to the frequency of transmission.

The reference signals transmitted during a phase error estimation procedure by the BS 300 are denoted as X′ and can be written as

$${X}^{′} ( k , n ) = X ( k , n ) Φ ( k , n ) , \qquad ( 3 )$$

where Φ is a phase ramp function. For the present embodiment, the phase ramp function can be written as

$$Φ ( k , n ) = \{ \begin{matrix}exp ( j ( ak + b ) ) , & n = 1 \\ 1 , & n = 0\end{matrix} , \qquad ( 4 )$$

where the parameter a may be set such that X′ exhibits rotation (e.g., at least a full 360 deg rotation) across the carrier bandwidth. In other words, X′ exhibits rotation (e.g., at least a full 360 deg rotation) over the frequency indices, k. The parameter b can be chosen arbitrarily and is set to 0 in the present analysis for simplicity.

It can be seen from equation 4 that, when Φ is applied to X, the BS 300 adjusts the phase of reference signals transmitted only from the radio branch with index n=1, whilst there is no adjustment to the phase of the reference signals transmitted from the radio branch with index n=0. That is, a phase ramp is applied only to the reference signals transmitted from one of the antennas of the multi-antenna system. The resolution of the phase ramp adjustments may be relatively fine (e.g., reference signals for the kth subcarrier may be shifted in phase by one or more degrees with respect to the (k+1)th subcarrier).

In this example, the phase ramp varies monotonically (e.g., linearly with respect to frequency) over the frequency range. In other examples, the phase ramp may have a different variation.

The phase-ramp function is invisible to the UE 302, and thus the UE is not informed that a phase ramp has been applied to the reference signals transmitted from one of the antennas of the multi-antenna system. As such, when measuring Y, the UE 302 considers Φ to be a channel impairment similar to H_{BS} and measures X′ the same way as it would measure X. Therefore, from the UE's 302 point of view, the reference signals received during the phase error estimation procedure can be written as

$$Y ( k , n ) = {H}_{BS} ( k , n ) Φ ( k , n ) X ( k , n ) . \qquad ( 5 )$$

The assistant wireless device performs measurements on the received reference signals (e.g., to measure the phase difference between the first and second reference signals) and reports those measurements to the network node. The measurements may comprise a co-phasing component of PMI feedback. As noted above, the measurements performed by the assistant wireless device are usually heavily quantized. For example, in one embodiment, the measurements utilize QPSK and therefore have a resolution of 90 degrees. Thus in step 406 the network node receives feedback from the assistant wireless device comprising indications of quantized measurements of the phase difference.

The assistant wireless device thus measures Y and estimates the channel over which the reference signals are transmitted. For example, the assistant wireless device may estimate the channel over which the reference signals are transmitted with respect to the frequency of the carrier of the multi-antenna system.

Having performed the channel estimation, the assistant wireless device is operable to transmit feedback of the channel estimation to the network node (e.g., either directly or indirectly via the BS 300). The feedback comprises indications of quantized measurements of phase difference between the received reference signals. In one embodiment, the feedback is in the form of PMI feedback. That is, the feedback comprises a PMI and the indications of quantized measurements of phase differences comprise (PMI) co-phasing components. The co-phasing components may be reported per sub-band of a frequency bandwidth of the carrier of the multi-antenna system.

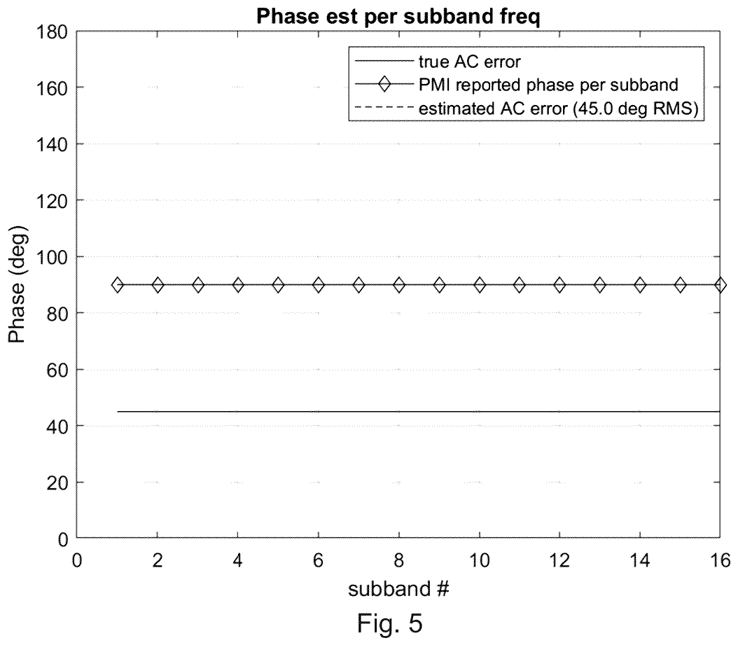

FIG. 5 is a graph showing the problem of quantization on phase-error measurements reported by the assistant wireless device. In this example, the phase error between the first and second antennas (that is, the simple black line) is approximately 45° at each frequency sub-band. The reported measurements of that value (the diamond-marked line) are quantized to 90°, and this is highly inaccurate.

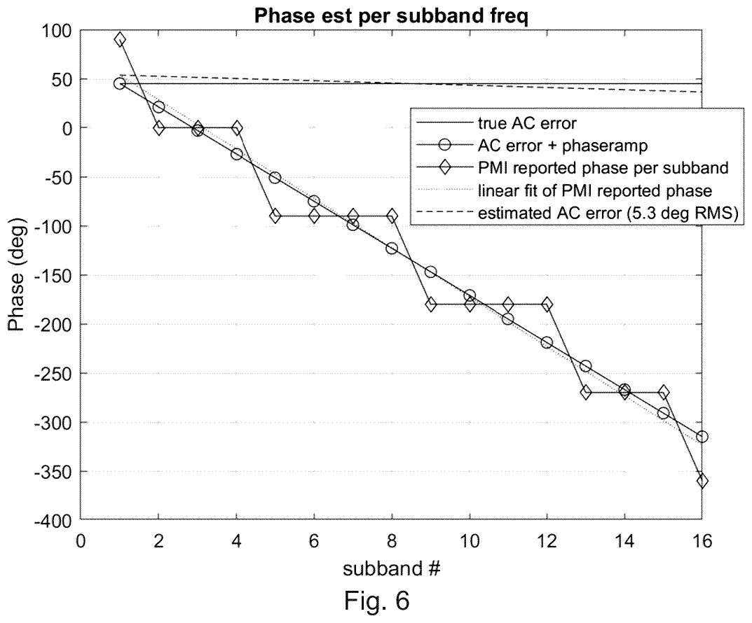

FIG. 6 is a graph of the same example, but showing steps taken according to embodiments of the disclosure. Thus, the phase error between first and second antennas (the simple black line) is again approximately 45°. A phase ramp is applied to the reference signals transmitted from one of the antennas, and thus the phase difference between the transmitted reference signals (the circle-marked line) varies with the frequency of transmission. In the example of FIG. 6, it can be seen that the applied phase ramp results in the phase difference between the two reference signals varying linearly with respect to the frequency sub-band of the carrier.

In FIG. 6, the diamond-marked line again illustrates the quantized measurements of phase difference between the two received reference signals with respect to the frequency sub-band of the carrier of the multi-antenna system (where a phase ramp has been applied to one of the reference signals). In comparison to FIG. 5, owing to the phase ramp, it can be seen that at least some of the quantized measurements of phase difference between the two received reference signals vary with respect to the frequency sub-band of the carrier.

Due to the nature of quantization, some of the quantized measurements of phase difference in FIG. 6 are underestimates of the phase difference between the two received reference signals (e.g., the quantized measurement for sub-band 2), whilst other values are overestimates (e.g., the quantized measurement for sub-band 4). In comparison, all of the quantized measurements of phase difference in FIG. 5 are overestimates of the phase difference between the two received reference signals. Furthermore, as seen in FIG. 6, some of the quantized measurements of phase difference are closer to their true values than others. Therefore, some of the quantized measurements of phase difference have larger rounding errors than others.

Upon receiving the channel estimation feedback, in some embodiments, the network node performs a phase unwrapping procedure on one or more of the quantized measurements of phase difference in step 408. That is, in the above analysis, the phase difference between the reference signals when no phase ramp is applied is modelled as frequency independent. This is done due to the fact that small to moderate variations in the phase difference between the received reference signals with respect to frequency (when no phase ramp is applied) have a minimal impact on the estimated phase difference between the received reference signals due to the minimal impact of this variation on the applied phase ramp.

However, a large variation in this phase difference with respect to frequency can have an additive/suppressing effect on the applied phase ramp, such that the gradient of the applied phase ramp as seen by the UE 302 will either be increased or decreased in comparison to the phase ramp defined by Φ. This can cause the quantized measurements of phase difference to become phase wrapped (i.e., the quantized measurements of phase difference at each frequency index are constrained between-180 degrees and 180 degrees). Such wrapping may cause issues when applying a fitting algorithm as set out in step 410 below. These issues can be avoided by performing a phase unwrapping procedure on the quantized measurements prior to using the fitting algorithm. Those skilled in the art will be aware of multiple methods for performing phase unwrapping. For example, the phase unwrapping procedure may comprise reversing the effects of constraining the quantized measurements of phase difference at each frequency index between −180 degrees and 180 degrees by applying (e.g., adding or subtracting) an appropriate multiple of 360 degrees to the quantized measurements.

In step 410, the network node applies a fitting algorithm or process to the quantized measurements of phase difference to generate a fitted relationship of the phase difference with respect to frequency over the frequency range. For example, the fitting algorithm may comprise a linear regression algorithm or process. In other embodiments, the fitting algorithm may comprise a non-linear regression algorithm or process (e.g., where the phase ramp is non-linear). In other words, the network node uses the received feedback to find a mathematical relationship between the quantized measurements of phase difference and the frequency of the transmission. For example, in some embodiments, this may comprise using a regression algorithm (e.g., a linear regression algorithm) to fit a model to the quantized measurements of phase difference.

Again, an example of such a fitted relationship is illustrated in FIG. 6 (the dotted line). In contrast to the example of FIG. 5, at least some of the quantized values of phase difference in FIG. 6 vary in magnitude with respect to the frequency of the reference signal. Thus, the accuracy of the fitted relationship is not limited by the quantized measurements all being rounded to the same quantized value. Furthermore, the accuracy of the fitted relationship is increased by the small rounding error of some of the quantized measurements of phase difference and the fact that not all of the quantized measurements are overestimates or underestimates of the phase difference between the received reference signals. Thus, an accurate fitted relationship can be found for the quantized measurements of phase difference with respect to the frequency of the reference signals. Whilst there may be some residual error associated with this model, it has a higher degree of accuracy and reliability than the model of FIG. 5.

In step 412, the network node removes, from the fitted relationship, the phase ramp to generate an estimate of the phase error between signals transmitted by the first and second antennas. For example, this may comprise subtracting any phase adjustments applied to one of the reference signals as a result of the applied phase ramp from the fitted relationship.

The dashed line in FIG. 6 illustrates the result of removing the phase ramp from the fitted relationship. The result is an accurate estimation of the phase difference between the received reference signals if the phase ramp were not applied, which varies only slightly in comparison to the actual phase difference between the received reference signals if the phase ramp were not applied (illustrated in FIG. 6 by the simple black line). Thus, the fitted relationship in FIG. 6 can be used to accurately estimate the phase difference between the received reference signals if the phase ramp were not applied.

In comparison, it can be seen in FIG. 5 that the fitted relationship does not result in an accurate estimation of the phase difference between the two received reference signals (illustrated in FIG. 5 by the diamond-marked line), as this estimation differs significantly from the actual phase difference between the received reference signals (illustrated in FIG. 5 by the simple black line). That is, the estimated phase difference is 90 degrees, whilst the actual phase difference is 45 degrees.

This estimate of the phase difference enables the BS 300 to find an estimate of a phase error between any signals transmitted from the two antennas. That is, the network node may be operable to compensate for the estimated phase error when transmitting signals from the multiple antennas of the multi-antenna system. For example, the BS 300 may calibrate the antennas to reduce the phase difference between signals transmitted by the multiple antennas 304 of the multi-antenna system.

Any residual error of the fitted relationship (i.e., a difference between the estimated phase relationship and the actual relationship) can be decreased by increasing the number of quantized measurements comprised in the feedback. For example, by increasing the number of sub-bands for which the quantized measurements of phase difference are reported, the fitting algorithm can more accurately find a fitted relationship between the quantized measurements of phase difference and the frequency of the carrier of the multi-antenna system. Thus, the resulting estimation of phase error generated from this fitted relationship has a reduced RMS error.

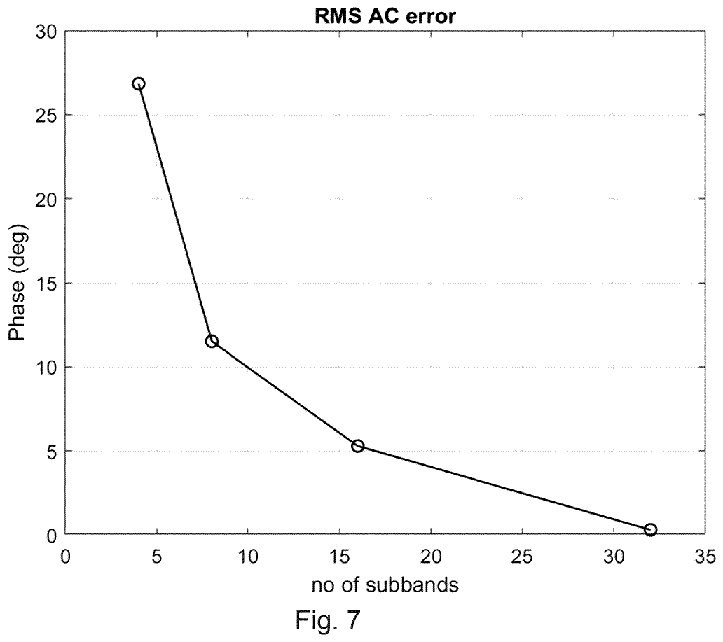

FIG. 7 is a graph showing the variation of this error with respect to the number of sub-bands reported by the assistant wireless device (using the same example of a 45 degree phase error as in FIGS. 5 and 6). As seen in FIG. 7, the RMS error decreases as the number of frequency sub-bands increases, with the RMS error approaching 0 at 32 sub-bands.

Whilst the aforementioned phase error estimation procedure is discussed only in the context of a two-antenna system, the skilled person would be able to adapt the methods discussed in the present disclosure such that the phase error between three or more antennas of a multi-antenna system can be estimated. For example, the phase error between three or more antennas can be estimated and compensated for by repeating the method described above with respect to FIG. 4 between respective pairs of the plurality of antennas. For example, one of the antennas may be chosen as a reference antenna, with the phase error of other antennas being determined relative to the first antenna.

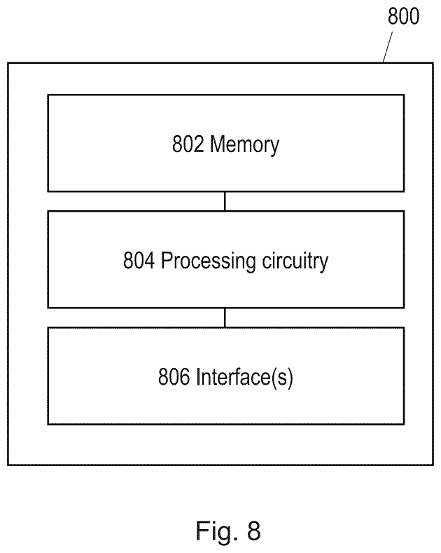

FIG. 8 illustrates a schematic block diagram of an apparatus 800 for estimating phase error between signals transmitted by a first antenna and a second antenna of a multi-antenna system. The first antenna is configured to transmit first reference signals to a wireless device (e.g., an assistant wireless device) and the second antenna is configured to transmit second reference signals to the wireless device. The first reference signals are configured with a phase ramp relative to the second reference signals over a frequency range of a carrier of the multi-antenna system.

The apparatus 800 may correspond to the network nodes 102, 208 discussed in relation to FIGS. 1 and 2 or the BS 300 discussed in relation to FIG. 3.

Apparatus 800 is operable to carry out the example method described with reference to FIG. 4 and possibly any other processes or methods disclosed herein. It is also to be understood that the method of FIG. 4 is not necessarily carried out solely by apparatus 800. At least some operations of the method can be performed by one or more other entities.

The apparatus 800 comprises processing circuitry 804 (such as one or more processors, digital signal processors, general purpose processing units, etc), a machine-readable medium 802 (e.g., memory such as read-only memory (ROM), random-access memory, cache memory, flash memory devices, optical storage devices, etc) and one or more interfaces 806.

In one embodiment, the machine-readable medium 802 contains (e.g. stores) instructions which are executable by the processor such that the apparatus is operable to receive, from the wireless device, feedback based on the first reference signals and the second reference signals. The feedback comprises indications of quantized measurements by the wireless device of phase difference between the first reference signals and the second reference signals over the frequency range. The apparatus 800 is further operable to apply a fitting algorithm to the quantized measurements of phase difference to generate a fitted relationship of the phase difference with respect to frequency over the frequency range. The apparatus 800 is further operable to remove, from the fitted relationship, the phase ramp to generate an estimate of the phase error between signals transmitted by the first antenna and the second antenna.

In some embodiments, the machine-readable medium 802 further contains instructions which are executable by the processor such that the apparatus 800 is operable to select an assistant wireless device. For example, the assistant wireless device may be the wireless device to which the first reference signals and the second reference signals are transmitted.

In some embodiments, the machine-readable medium 802 further contains instructions which are executable by the processor such that the apparatus 800 is operable to cause transmission of the first reference signal and the second reference signal to the wireless device.

In some embodiments, the machine-readable medium 802 further contains instructions which are executable by the processor such that the apparatus 800 is operable to perform a phase unwrapping procedure on one or more of the quantized measurements of phase difference.

In some embodiments, the machine-readable medium 802 further contains instructions which are executable by the processor such that the apparatus 800 is operable to compensate for the estimated phase error when transmitting signals from the first antenna and the second antenna.

Thus, the machine-readable medium may store instructions which, when executed by the processing circuitry 804, cause the apparatus 800 to perform the steps described above.

In other embodiments, the processing circuitry 804 may be configured to directly perform the method, or to cause the apparatus 800 to perform the method, without executing instructions stored in the non-transitory machine-readable medium 802, e.g., through suitably configured dedicated circuitry.

The one or more interfaces 806 may comprise hardware and/or software suitable for communicating with other nodes of the communication network using any suitable communication medium. For example, the interfaces 806 may comprise one or more wired interfaces, using optical or electrical transmission media. Such interfaces may therefore utilize optical or electrical transmitters and receivers, as well as the necessary software to encode and decode signals transmitted via the interface. In a further example, the interfaces 806 may comprise one or more wireless interfaces. Such interfaces may therefore utilize one or more antennas, baseband circuitry, etc. The components are illustrated coupled together in series; however, those skilled in the art will appreciate that the components may be coupled together in any suitable manner (e.g., via a system bus or suchlike).

In further embodiments of the disclosure, the apparatus 800 may comprise power circuitry (not illustrated). The power circuitry may comprise, or be coupled to, power management circuitry and is configured to supply the components of apparatus 800 with power for performing the functionality described herein. Power circuitry may receive power from a power source. The power source and/or power circuitry may be configured to provide power to the various components of apparatus 800 in a form suitable for the respective components (e.g., at a voltage and current level needed for each respective component). The power source may either be included in, or external to, the power circuitry and/or the apparatus 800. For example, the apparatus 800 may be connectable to an external power source (e.g., an electricity outlet) via an input circuitry or interface such as an electrical cable, whereby the external power source supplies power to the power circuitry. As a further example, the power source may comprise a source of power in the form of a battery or battery pack which is connected to, or integrated in, the power circuitry. The battery may provide backup power should the external power source fail. Other types of power sources, such as photovoltaic devices, may also be used.

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim, “a” or “an” does not exclude a plurality, and a single processor or other unit may fulfil the functions of several units recited in the statements below. Where the terms, “first”, “second” etc. are used they are to be understood merely as labels for the convenient identification of a particular feature. In particular, they are not to be interpreted as describing the first or the second feature of a plurality of such features (i.e. the first or second of such features to occur in time or space) unless explicitly stated otherwise. Steps in the methods disclosed herein may be carried out in any order unless expressly otherwise stated. Any reference signs in the statements shall not be construed so as to limit their scope.

1. A method performed by a network node for estimating phase error between signals transmitted by a first antenna and a second antenna of a multi-antenna system, wherein the first antenna is configured to transmit first reference signals to a wireless device and the second antenna is configured to transmit second reference signals to the wireless device, wherein the first reference signals are configured with a phase ramp relative to the second reference signals over a frequency range of a carrier of the multi-antenna system, the method comprising:
receiving, from the wireless device, feedback based on the first reference signals and the second reference signals, wherein the feedback comprises indications of quantized measurements by the wireless device of phase difference between the first reference signals and the second reference signals over the frequency range;
applying a fitting algorithm to the quantized measurements of phase difference to generate a fitted relationship of phase difference with respect to frequency over the frequency range; and
removing, from the fitted relationship, the phase ramp to generate an estimate of the phase error between signals transmitted by the first antenna and the second antenna.

2. The method according to claim 1, wherein the frequency range comprises a plurality of frequency sub-bands, and one or more of the quantized measurements of phase difference correspond to quantized measurements at respective frequency sub-bands.

3. The method according to claim 1, wherein the phase ramp varies monotonically over the frequency range.

4. The method according to claim 3, wherein the phase ramp varies linearly with respect to frequency over the frequency range.

5. The method according to claim 1, wherein the phase ramp spans at least 360 degrees over the frequency range.

6. The method according to claim 1, wherein the fitting algorithm comprises a linear regression algorithm.

7. The method according to claim 1, further comprising:
performing a phase unwrapping procedure on one or more of the quantized measurements of phase difference.

8. The method according to claim 1, further comprising:
compensating for the estimated phase error when transmitting signals from the first antenna and the second antenna.

9. The method according to claim 1, wherein the feedback comprises a Pre-coding Matrix Indicator.

10. The method according to claim 9, wherein the indications of quantized measurements of phase difference comprise PMI feedback co-phasing components.

11. The method according to claim 1, wherein the frequency range comprises a bandwidth of the carrier.

12. The method according to claim 1, wherein the first reference signal and the second reference signal comprise Channel State Information, CSI, Reference Signals, RS.

13. The method according to claim 1, wherein the multi-antenna system comprises an advanced antenna system, AAS.

14. The method according to claim 1, wherein the multi-antenna system comprises a distributed multiple-input, multiple-output system, D-MIMO.

15. The method according to claim 1, wherein the network node is co-located with the first and second antennas.

16. The method according to claim 1, wherein the method is performed by a network node that is communicatively coupled to the multi-antenna system.

17. The method according to claim 16, wherein the network node comprises a centralized unit of a distributed base station.

18. A network node for estimating phase error between signals transmitted by a first antenna and a second antenna of a multi-antenna system, wherein the first antenna is configured to transmit first reference signals to a wireless device and the second antenna is configured to transmit second reference signals to the wireless device, wherein the first reference signals are configured with a phase ramp relative to the second reference signals over a frequency range of a carrier of the multi-antenna system, the network node comprising processing circuitry configured to cause the network node to:
receive, from the wireless device, feedback based on the first reference signals and the second reference signals, wherein the feedback comprises indications of quantized measurements by the wireless device of phase difference between the first reference signals and the second reference signals over the frequency range;
apply a fitting algorithm to the quantized measurements of phase difference to generate a fitted relationship of the phase difference with respect to frequency over the frequency range; and
remove, from the fitted relationship, the phase ramp to generate an estimate of the phase error between signals transmitted by the first antenna and the second antenna.

19. The network node according to claim 18, wherein the frequency range comprises a plurality of frequency sub-bands, and one or more of the quantized measurements of phase difference correspond to quantized measurements at respective frequency sub-bands.

20. The network node according to claim 18, wherein the phase ramp varies monotonically over the frequency range.

21.-34. (canceled)
